(19) United States
(12) Patent Application Publication
(10) Pub. No.: US 2026/0157263 A1
(43) Pub. Date: Jun. 11, 2026

(54) BAR TYPE BEARING STRUCTURE FOR AGRICULTURAL MACHINES, SUCH AS PRECISION SOWERS, AND SOWER INCLUDING SAID STRUCTURE

(71) Applicant: MASCHIO GASPARDO S.P.A., Campodarsego (PD) (IT)

(72) Inventors: Andrea MASCHIO, Morsano Al Tagliamento (IT); Mario MOGLIONI, San Vito Al Tagliamento (IT); Rudy MARTIN, Padova (IT)

(21) Appl. No.: 19/127,315

(22) PCT Filed: Nov. 6, 2023
(86) PCT No.: PCT/IB2023/061182

§ 371 Date: May 5, 2025

(30) Foreign Application Priority Data
Nov. 4, 2022 (IT) 102022000022809

(51) Int. Cl. A01C 7/08; A01B 63/00; A01C 7/20

(52) U.S. Cl. CPC A01C 7/082; A01B 63/002; A01C 7/208

(57) ABSTRACT

A bar type bearing structure (1) for agricultural machines, such as precision sowers, includes at least one main beam (2) having opposite axial ends, at least one of which is provided to be closed by a removable cover and at least one secondary beam (11) which can be removably connected to an axial end of the main beam (2) in axial extension thereof in place of the removable cover. The main beam (2) and the at least one secondary beam (11) are configured as closed tubular structures at least when they are connected to each other and include arrangements for attachments for sowing elements and for a levelling system and respective service pipes (20). The service pipes (20) are provided inside the tubular structure (1) of the main beam (2) and secondary beam (11) and are provided with connectors (21) for connecting the corresponding service pipes (20) in the main beam (2) and secondary beam (11) to each other and connectors (21) which are provided on the main beam (2) and secondary beam (11) in order to connect them to the respective sowing and levelling elements.

The invention relates to a bar type bearing structure for agricultural machines, such as precision sowers, including the features set out in the preamble of the main claim.

The invention further relates to a sower including said structure.

A structure including these features is known, for example, from U.S. Pat. No. 10,448,560. Bar type bearing structures intended for being fitted to agricultural machines are further known from US 2019 000009, US 2016 135360, U.S. Pat. No. 9,554,505, U.S. Pat. No. 8,567,517, US 2014 0060867, U.S. Pat. No. 4,151,886, U.S. Pat. No. 4,453,601, U.S. Pat. No. 4,729,435, U.S. Pat. No. 4,453,601, U.S. Pat. No. 10/448,560 and U.S. Pat. No. 4,151,886.

The structure described in U.S. Pat. No. 10/448,560 is constructed, as is the present invention, to be fitted with a plurality of sowing elements, preferably of the type with pneumatic operation, for precision sowing.

The solution described proposes the use of the bar as pipes for connecting at the sowing elements to a pressure reduction system which is used by the sowing elements for the singularization of the seeds in accordance with methods known per se.

This solution is advantageous because it reduces the number of pipes which are mounted outside the machine and which are therefore exposed to potential damage resulting from impacts and wear.

However, the system constitutes only a partial solution to the problem because it protects only the connection between the sowing elements and the reduced-pressure pneumatic circuit. Nothing is proposed with regard to other users.

The technical problem addressed by the invention is to implement a bar type bearing structure which is structurally and functionally configured to overcome the disadvantages set out with reference to the cited prior art.

This problem is solved by the invention with a bar type bearing structure constructed according to one or more of the appended claims.

According to an aspect of the invention, a bar type bearing structure for agricultural machines, and in particular for constructing precision sowers, comprises at least one main beam having opposite axial ends, at least one of which is preferably provided to be closed by a removable cover and at least one secondary beam which can be removably connected to an axial end of the main beam in axial extension thereof, preferably in place of the removable cover. Preferably, both the main beam and the at least one secondary beam are configured as closed tubular structures at least when they are connected to each other or when the main beam is closed by the cover. Preferably, the main beam and the at least one secondary beam include arrangements for attachments for sowing elements and for a levelling system. In a preferred solution, these arrangements include on the main beam respective service pipes. In an exemplary embodiment of the invention, the service pipes are provided inside the tubular structure of the main beam and secondary beam and are provided with connectors for connecting the corresponding service pipes in the main beam and secondary beam to each other. Furthermore, connectors are provided on the main beam and secondary beam in order to connect the service pipes to the respective sowing and levelling elements. In this manner, the secondary beams can be mounted in extension of the main beam with a simplified intervention without requiring any extraneous material to be provided.

According to a second aspect of the invention, the main beam is connected to a first pneumatic system for the seed singularization. In this case, it is preferable that, in the region of the arrangements for attachments for sowing elements on the at least one main beam and secondary beam, there are provided feedthrough connectors for connecting the first pneumatic system to the sowing elements by means of the beams. Use is thereby made of the main beam and secondary beam (or beams, where there is more than one) as supply pipe for the pressurization of the first system to the various sowing elements.

According to another aspect of the invention, the main beam is connected to a second pneumatic positive pressure system. In this case, it is preferable that, in the region of the arrangements for attachments for sowing elements on the at least one main beam and secondary beam, there are provided feedthrough connectors for connecting the second pneumatic system to the sowing elements by means of the service pipes. In this manner, the service pipes are provided and protected inside the main beam and secondary beam.

In a preferred solution, the service pipes of the main beam and secondary beam can be connected to each other.

In an advantageous option, the secondary beams are two beams, provided for connection to the corresponding axial end of the respective at least one main beam.

Preferably, the arrangements for attachments on the secondary beam are two for two corresponding sowing elements.

Preferably, there are used two main beams which are articulated to a carriage and preferably carried in an oscillating manner, in particular from an operating position, in which the main beams are, for example, extended and aligned axially one in extension of the other, to a transport position, in which the main beams are preferably orientated upwards and collected together towards the carriage in order to limit the spatial requirement thereof on roads. Therefore, it will be appreciated that, in this context, the term “in an oscillating manner” is preferably intended to be understood to mean “in a movable manner” and more particularly “in a tilting manner” or “in a folding manner”. Preferably, there is included a respective levelling system which can be transferred from the main beam to the corresponding secondary beam, the levelling system being fed by means of service pipes which extend into the main beam and which can be connected to respective service pipes which are provided in the at least one secondary beam.

The features and advantages of the invention will be better understood from the detailed description of a preferred exemplary embodiment thereof which is illustrated, by way of non-limiting example, with reference to the appended drawings, in which:

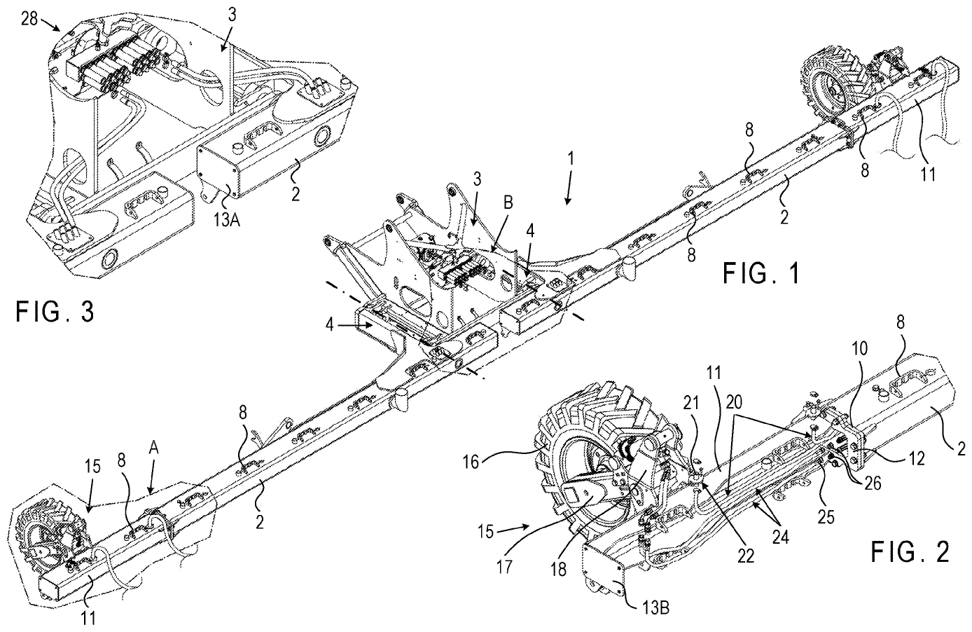

FIG. 1 is a perspective view of the bar type bearing structure according to the present invention;

FIGS. 2 and 3 are two detailed views of the bar type bearing structure of FIG. 1;

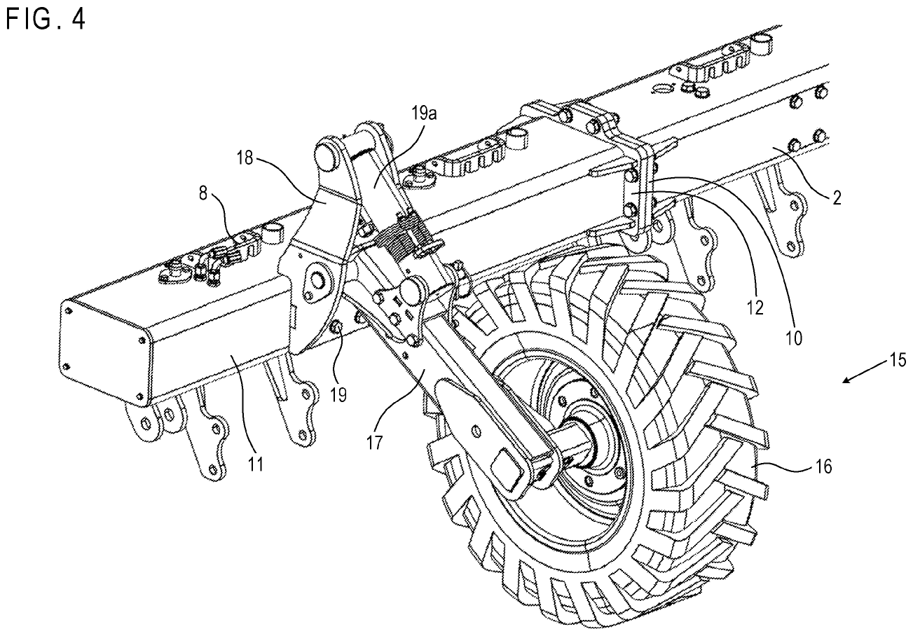

FIG. 4 is another perspective view of the present invention.

In the Figures, there is generally designated 1 a bar type bearing structure according to the present invention. In the exemplary embodiment proposed, the structure 1 comprises two main beams 2 which extend at opposite sides of a carriage 3 to which they are preferably hinged by means of respective hinge members 4. The hinge members 4 are in turn provided with hydraulic cylinders which are not illustrated in the Figures or similar movement means which allow the respective main beam 2 to be oscillated from an operating position, in which these beams 2 are extended and aligned axially one in extension of the other, to a transport position, in which they are oscillated upwards and collected together towards the carriage 3 in order to limit the spatial requirement thereof on roads.

There is further provision, for bearing bars with smaller dimensions, for the main beam 2 to be a single beam and/or non-foldable.

There are provided on the main beams 2 arrangements 8 for attachments for sowing elements which are not illustrated, preferably of the type with pneumatic seed singularization.

In preferred embodiments, these arrangements 8 are spaced apart at intervals. The sowing elements may, for example, be of the type described in WO 2017/182997 by the same Applicant or of other types, which are conventional per se. If use is made of sowing elements of the type described in WO 2017/182997, there is preferably mounted on the carriage 3 a distributor which is associated with an air compressor which serves to supply compressed air to the above-mentioned sowing elements which require, for the correct operation thereof, supply both with a first pneumatic system (with negative or positive pressure), for the singularization of the seed, and with a second pneumatic system with positive pressure in order to accelerate the seed when falling towards the sowing furrow. However, other conventional systems require only the first pneumatic system for the singularization of the seed. In this case, the distributor and relevant air compressor may be omitted.

Where provided, the distributor is connected to a multiple collector which is provided on the main beam near the carriage 3.

Both the main beams 2 terminate, at the opposite side to the hinge members 4, in a flange 10 or other equivalent means which allows the removable closure thereof by means of a cover, which is not illustrated in the Figures.

The invention further provides for one or both main beams 2 to be extensible by adding respective secondary beams 11 which are also provided with flanges 12 in order to allow them to be connected to the flange 10 of the main beam 2, preferably in place of the cover. The cover can be used to close the opposite end of the secondary beam 11 which can be provided with a flange for this purpose.

There are also provided on the secondary beam 11 arrangements 8 for attachments which are identical to those of the main beam so that it is possible to add additional sowing elements to the secondary beam 11 in an equivalent manner to the main beam 2.

Both the main beams 2 and the secondary beams 11 are further provided with attachments for a respective levelling element or system 15 including a wheel 16 which can pivot with respect to the beams 2, 11 by means of an oscillating arm 17 which is carried by a bracket 18. The bracket 18 is in turn removably fixed, for example, by means of screw/bolt connections 19 in pre-established positions of the respective beam 2, 11. There is preferably interposed between the bracket 18 and the arm 17 an actuator 19A, such as a hydraulic or pneumatic cylinder, which allows the respective beam 2, 11 to be levelled by varying the height thereof from the ground at the corresponding end.

The two main and secondary beams 11 are in the form of box-shaped tubular elements so that, once they are connected to each other, the main and secondary beams form a single tubular element which is closed at the end of the beam 2 which is directed towards the carriage 3 by a plate 13A and which is removably closed at the opposite end by a closure element 13B, for example, the cover.

In this manner, the main and secondary beams 2, 11 can advantageously be used to connect the sowing elements to a first pneumatic pressurization system (positive or negative with respect to the external environment) in order to control the seed singularization function. The type of pressurization depends on the construction specifications of the sowing elements used. The first pneumatic pressurization system is, for example, connected by means of a connection to each of the main beams 2 and by means of a respective connection 22, which is provided in the region of each attachment arrangement 8, to the respective sowing element by means of a pipe which is not illustrated. Respective service pipes are further received inside the main beams. A first series of service pipes is constituted by pipes 20 for compressed air which extend from a respective opening of the multiple collector 28 as far as feedthrough collectors or connectors 21 which are provided on the main and secondary beams near the arrangements 8 for attachments. The feedthroughs 21 are therefore connected to the respective sowing unit by means of a flexible pipe which is not illustrated. Optionally, the service pipes may comprise delivery and return pipes 24 for a hydro-pneumatic fluid for controlling the cylinder of the levelling system 15. The secondary beam contains the same pipe arrangements 20 and 24 in sections which have a length corresponding to the extent of the secondary beam and which can be connected to the corresponding pipes and tubes in the main beam by means of connections 25 and sleeves 26. The pipes 20 for compressed air of the secondary beam are in turn connected to the pipes 20 which are provided in the main beam until being connected to the corresponding opening of the multiple collector 28.

Therefore, the invention allows the conversion of a precision sower by adding or removing, depending on necessity, sowing elements. For example, it is possible to convert a sower with 12 rows into one with 16 rows by adding to the main beams the respective secondary beams and the corresponding sowing elements. This is carried out by removing the end covers of the main beams and connecting, in axial extension thereof, the respective secondary beams. The connection is carried out via the respective flanged connections by adding, where necessary, a seal made of paste in order to improve the air-tightness. Therefore, the covers are repositioned at the terminal ends of the secondary beams 11, closing them. If necessary, before these operations are carried out, there are connected the service pipes and the levelling elements are repositioned. The invention thereby solves the problem proposed, affording the evident advantages of allowing adaptation of the bar type bearing structure of an agricultural machine, particularly a sower, to the commercial requirements, for example, by increasing the number of sowing elements which are fitted to it, providing all the arrangements necessary in the same secondary beams and therefore making this conversion easy and immediate even for a farmer who does not have specific knowledge of the mechanical construction of an agricultural machine.

1. A bar type bearing structure for agricultural machines, such as precision sowers, including at least one main beam having opposite axial ends, at least one of which is provided to be closed by a removable cover and at least one secondary beam which can be removably connected to an axial end of the main beam in axial extension thereof in place of the removable cover, the main beam and the at least one secondary beam being configured as closed tubular structures at least when they are connected to each other or when the main beam is closed by the cover, the main beam and the at least one secondary beam including arrangements for attachments for sowing elements and for a levelling system, the arrangements including on the main beam respective service pipes wherein the service pipes are provided inside the tubular structure of the main beam and secondary beam and are provided with connectors for connecting the corresponding service pipes in the main beam and secondary beam to each other and connectors which are provided on the main beam and secondary beam in order to connect the service pipes to the respective sowing and levelling elements.

2. The bar type bearing structure according to claim 1, wherein the at least one main beam is connected to a first pneumatic system for the seed singularization.

3. The bar type bearing structure according to claim 1, wherein the at least one main beam is connected to a second pneumatic positive pressure system.

4. The bar type bearing structure according to claim 2, wherein in the region of the arrangements for attachments for sowing elements on the at least one main beam and secondary beam there are provided feedthrough connectors for connecting through the beams the first pneumatic system to the sowing elements.

5. The bar type bearing structure according to claim 1, wherein the service pipes which can be connected to each other are provided in the main beam and secondary beam.

6. The bar type bearing structure according to claim 3, wherein there are provided auxiliary feedthrough connectors for connecting the second pneumatic system to the sowing elements through the service pipes in the region of the arrangements for attachments for sowing elements on the at least one main beam and secondary beam.

7. The bar type bearing structure according to claim 1, wherein the secondary beams are two beams, provided for connection to the corresponding axial end of the respective at least one main beam.

8. The bar type bearing structure according to claim 1, wherein the arrangements for attachments on the secondary beam are two for two corresponding sowing elements.

9. The bar type bearing structure according to claim 1, wherein two main beams are articulated to a carriage in an oscillating manner.

10. The bar type bearing structure according to claim 9, wherein the two main beams extend at opposite sides of the carriage at which they are hinged of through respective hinge members.

11. The bar type bearing structure according to claim 10, wherein the hinge members are provided with a movement system which allows the respective main beam to be oscillated from an operating position, in which the main beams are extended and aligned axially one in extension of the other, to a transport position, in which they are oscillated upwards and collected together towards the carriage in order to limit the spatial requirement thereof on roads.

12. The bar type bearing structure according to claim 1, including a respective levelling system which can be transferred from the main beam to the corresponding secondary beam, the levelling system being fed by the service pipes which pass through the main beam and which can be connected to respective service pipes which are provided in the at least one secondary beam.

13. The bar type bearing structure according to claim 12, wherein the respective levelling system includes a wheel which can tilt with respect to the beams through an oscillating arm which is carried by a bracket.

14. The bar type bearing structure according to claim 13, wherein the bracket is removably fixed in pre-established positions of the respective beam.

15. The bar type bearing structure according to claim 13, wherein there is interposed between the bracket and the arm a hydraulic or pneumatic cylinder which allows the respective beam to be levelled by varying the height thereof from the ground at the corresponding end, the service pipes comprising delivery and return pipes for a hydro-pneumatic control fluid for the cylinder of the levelling system.

16. A bar type bearing structure for agricultural machines, such as precision sowers, including at least one main beam having opposite axial ends, at least one of which is provided to be closed by a removable cover and at least one secondary beam which can be removably connected to an axial end of the main beam in axial extension thereof in place of the removable cover, the main beam and the at least one secondary beam being configured as closed tubular structures at least when they are connected to each other or when the main beam is closed by the cover, the main beam and the at least one secondary beam including arrangements for attachments for sowing elements and for a levelling system, the arrangements including on the main beam respective service pipes, wherein the service pipes are provided inside the tubular structure of the main beam and secondary beam and are provided with connectors for connecting the corresponding service pipes in the main beam and secondary beam to each other and connectors which are provided on the main beam and secondary beam in order to connect the service pipes to the respective sowing and levelling elements, wherein the at least one main beam is connected both to a first pneumatic system for the seed singularization and to a second pneumatic positive pressure system.

17. The bar type bearing structure according to claim 16, wherein in the region of the arrangements for attachments for sowing elements on the at least one main beam and secondary beam there are provided feedthrough connectors for connecting through the beams the first pneumatic system to the sowing elements and/or for connecting the second pneumatic system to the sowing elements through the service pipes.

18. The bar type bearing structure according to claim 16, wherein the service pipes which can be connected to each other are provided in the main beam and secondary beam.

19. A bar type bearing structure for agricultural machines, such as precision sowers, including at least one main beam having opposite axial ends, at least one of which is provided to be closed by a removable cover and at least one secondary beam which can be removably connected to an axial end of the main beam in axial extension thereof in place of the removable cover, the main beam and the at least one secondary beam being configured as closed tubular structures at least when they are connected to each other or when the main beam is closed by the cover, the main beam and the at least one secondary beam including arrangements for attachments for sowing elements and for a levelling system, the arrangements including on the main beam respective service pipes, wherein the service pipes are provided inside the tubular structure of the main beam and secondary beam and are provided with connectors for connecting the corresponding service pipes in the main beam and secondary beam to each other and connectors which are provided on the main beam and secondary beam in order to connect the service pipes to the respective sowing and levelling elements, wherein two main beams are articulated to a carriage in an oscillating manner, and wherein the secondary beams are two beams, provided for connection to the corresponding axial end of the respective two main beams.

20. The bar type bearing structure according to claim 19, wherein the two main beams extend at opposite sides of the carriage at which they are hinged through respective hinge members.
